(19) United States
(12) Patent Application Publication
(10) Pub. No.: US 2002/0013665 A1
(43) Pub. Date: Jan. 31, 2002

(54) Method and system for calculating kill ratio, degree of contribution to yield by defect specie, and yield of final products, and computer program for implementing calculation of kill ratio

(75) Inventor: Hiroaki Kikuchi, Tokyo (JP)

Correspondence Address: David A. Blumenthal, FOLEY & LARDNER, Suite 500, 3000 K Street, N.W., Washington, DC, 20007-5109, US

(73) Assignee: NEC CORPORATION

(21) Appl. No.: 09/883,248

(22) Filed: Jun. 19, 2001

(30) Foreign Application Priority Data
Jun. 19, 2000 (JP) 2000-182518

(51) Int. Cl. G01B 5/28

(52) U.S. Cl. 702/35

(57) ABSTRACT

The present invention provides a method of calculating a kill ratio of an attended defect specie, the method comprising the steps of extracting plural defect specie correspondent sets of die investigation data, and the plural defect specie correspondent sets corresponding to plural recognized defect species, and the plural recognized defect species including not only the attended defect specie but also one or more non-attended defect specie; and implementing a numerical analysis by using the extracted plural defect specie correspondent sets of die investigation data for not only the attended defect specie but also the one or more non-attended defect species, thereby to calculate a kill ratio of the attended defect specie.

### BACKGROUND OF THE INVENTION

1. Field of the Invention

The present invention relates to a data processor for calculating a kill ratio, and a method of calculating the kill ratio, as well as a computer program for implementing a calculation of the kill ratio.

2. Description of the Related Ant

A mass-production of integrated circuit chips has been made, wherein a single semiconductor wafer is divided into plural dies. Integrated circuits having the sane circuit configuration are formed on the divided plural dies for obtaining plural integrated circuit chips. Methods of improving and predicting the yield of the mass-produced IC chips have been studied. A method of finding an index for improving the yield and a method of predicting the yield of the integrated circuit chips have been made based on the kill ratio of defects, wherein the kill ratio may be calculated from die-investigation data for past-dies or data for yield. These methods utilizing the kill ratio are extremely convenient and highly general. The kill ratio is defined to be an expected probability of recognizing IC chips defective due to defect of a single-attended specie, which is present in the dies divided from the single semiconductor wafers. For example, if the single-attended specie defective is present in a single-attended die, this single-attended die is not always recognized defective. If the single-attended specie defect is present in other die than the single-attended die, then the single-attended die may be recognized defective due to a different specie defect.

Die-investigation data are defined to include die-identification data for identifying the dies, defective-indication data for indicating defective or non-defective in view of each of the defect species, and product-defective-indication data for indicating defective or non-defective of each of the product IC chips. The die-investigation data are registered in each of the fabrication processes for the single wafer.

The above-described defective-indication data may be collected from plural dies in each of the plural fabrication processes for mass-production of the IC chips. The above-described product-defective-indication data may be collected from final inspection to the IC chips as the final products. The above-described index for improving the yield indicates respective degrees of influence of the respective recognized defect species to the yield, A limited yield may be a partial index for improving the yield, wherein the limited yield is a yield in the presence of only the single-attended specie defect over the each wafer.

Respective defective priorities for recognizing “defective” may be given to the defect species based on this index for improving the yield, for example, the limited yields. The prediction for the yield of the mass-produced IC chips is an expected yield from the defective-indication data for indicating defective or non-defective in view of each of the, defect species, wherein the expected yield is independent from the inspection to the final projects IC chips.

For simplification of the description, the following will refer the plural die-investigation data for only a single wafer and a single fabrication process. Notwithstanding, the die-investigation data arc stored in a single lot for plural fabrication processes for fabricating the single wafer. The plural lots of the die-investigation data for the plural wafers are accumulated.

FIG. 1A is a plan view of a wafer including die-divided chips which are square-shaped. A white-color square represents the non-defective chip. A gray-color square represents the defective chip. A gray-color circle represents the attended-specie defect. FIG. 1B is a plane view of sorted arrangement in view of four categories of the chips of FIG. 1A. The die-investigation data for the plural dies from the single wafer are sorted into the following four groups.

A first group 901 is that the attended specie defect is present and the final product IC chip is non-defective. A second group 902 is that the attended specie defect is present and the final product IC chip is defective. A third group 903 is that the attended specie defect is absent and the final product IC chip is non-defective. A fourth group 904 is that the attended specie defect is absent and the final product IC chip is defective.

The kill ratio “KR′” for the single-attended specie defect is given by the following equation (1).

KR′=1−(TG′/T′) (1)

where T′ is the total number of defective and non-defective dies having the presence of the defects of the single-attended specie, and TG′ is the number of only the non-defective dies having the presence of defect of the single-attended specie.

The kill ratio in view of attending one specie defect from the plural species defects may be calculated from the above equation (1). The limited yield “LY′”, which indicates a ratio of the non-defective IC chips as final products in the presence of only the attended specie defects on the dies is given by the following equation (2).

LY′=1−KR′×T′/T (2)

where T is the total number of all of the dies including defective and non-defective dies.

As described above, if the limited yield is calculated by attending one specie of the plural species defects, and all of the limited yields are calculated for all defect species, then the respective degrees of influences of the respective recognized defect species to the yield may be expected.

A total yield “Y”, which indicates a ratio of defective IC chips as final products due to all species defects, is given by the following equation (3).

Y=II(1−KRi×Ti/T) (3)

where “Y” is the yield of the IC chips as the final products, namely “Y” is a ratio of the defective IC chips to the number of the defects, and “KRi” is the kill ratio for the defect specie “i”, and “T′” is the total number of the dies having the presence of the defects “i”.

The above conventional method of calculating the kill ratio is made without consideration of the defective IC chips having the presence of non-attended defects, for which reason the accuracy in calculating the kill ratio is not high.

Another conventional method for calculating the kill ratio at a higher accuracy was proposed. It is assumed that the defects of all species are, distributed in random over an entire region of the semiconductor wafer, and also assumed that any die has the co-presence of the attended specie defect and non-attended plural species defects. A ratio of the non-defective dies free of the attended-specie defects is detected. This detected ratio is defined to be a “base line yield” for the intended-specie defect. The base line yield “Yb′” for the attended-specie defect is given by the following equation (4).

Yb′=(TG−TG′)/(T−T′) (4)

where “T” is the total number of the dies, and “TG” is the number of the non-defective dies.

The equation (4) is incorporated into the above equation (1) to eliminate the influences by the non-attended specie defects from the kill ratio of the dies having the presence of the attended defects. The kill ratio “KR” is given by the following equation (5).

$$\begin{matrix}{KR}^{′} = 1 - ( {TG}^{′} / {T}^{′} ) / {Yb}^{′} \\ = 1 - [ {TG}^{′} ( T - {T}^{′} ) ] / [ {T}^{′} ( TG - {TG}^{′} ) ]\end{matrix} \qquad ( 5 )$$

The limited yield is defined to be a ratio of defective IC chips as final products when the attended-specie defects “A” are present in the dies. This limited yield may be considered to be an index which indicates an influence of the attended-specie defects to the yield. The limited yield “LY′” is given by the following equation (6).

LY′=1−KR′×T′/T (6)

All of the respective limited yields for all of the defect species are calculated separately, so as to recognize respective influences by the respective recognized defect species to the yield. All of the kill ratios for all of the defect species are calculated separately. The yield “Y” as a ratio of the defective IC chips as the final products is given by the following equation (7).

Y=IILYj (7)

wherein “LYj” is the limited yield for the defect specie “j”.

An estimation of the yield of the lot is made based on the above equation (7), so that the number of the input wafers may be decided depending on the estimated yield, in order to avoid waste input of the wafers, shorten the process time and reduce the consumption of the raw materials.

The above described conventional method of calculating the kill ratio for the attended-specie defect is highly accurate calculation method due to eliminating the influences by the non-attended specie defects to the yield assumed that the respective species defects are uniformly distributed over the wafer. The limited yield of the attended-specie defects is calculated from the kill ratio for the attended-specie defect. The limited yields and the total yield are also highly accurate, assumed that the respective species defects are uniformly distributed over the wafer.

The above conventional methods do not consider the number of the attended specie defects in a single die, assumed that the respective species defects are uniformly distributed over the wafer. Therefore, the number of the attended-specie defects in the single die may provide an influence to the accuracy in calculating the kill ratio, the limited yields and the total yield, even it is assumed that the respective species defects are uniformly distributed over the wafer.

If the respective species defects are non-uniformly distributed over the wafer, then the accuracy in calculating the kill ratio, the limited yields and the total yield is not so high.

In the above circumstances, the development of a novel method and apparatus for processing data free from the above problems is desirable.

### SUMMARY OF THE INVENTION

Accordingly, it is an object of the present invention to provide a novel method of calculating kill ratios, maximum yields and total yields free from the above problems.

It is a further object of the present invention to provide a novel method for highly accurate calculations of the kill ratios, the indexes for influences by respective species defects to the limited yields and the estimated total yield.

The present invention provides a method of calculating a kill ratio of an attended defect specie; the method comprising the steps of: extracting plural defect specie correspondent sets of die investigation data, and the plural defect specie correspondent sets corresponding to plural recognized defect species, and the plural recognized defect species including not only the attended defect specie but also one or more non-attended defect specie; and implementing, a numerical analysis by using the extracted plural defect specie correspondent sets of die investigation data for not only the attended defect specie but also the one or more non-attended defect species, thereby to calculate a kill ratio of the attended defect specie.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1A is a plan view of a wafer including die-divided chips which are square-shaped.

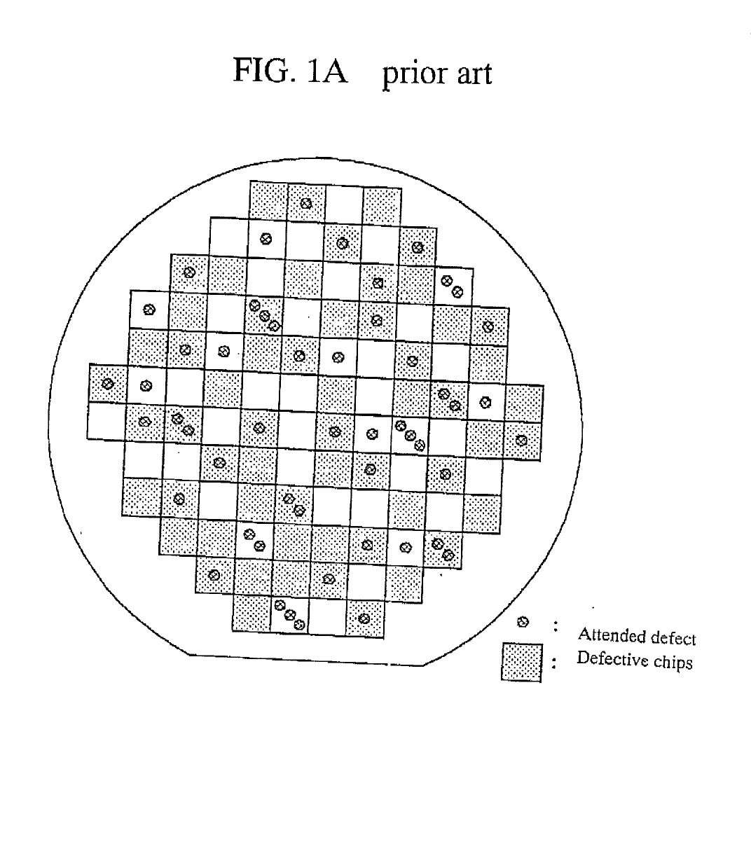

FIG. 1B is a plan view of sorted arrangement in view of four categories of the chips of FIG. 1A.

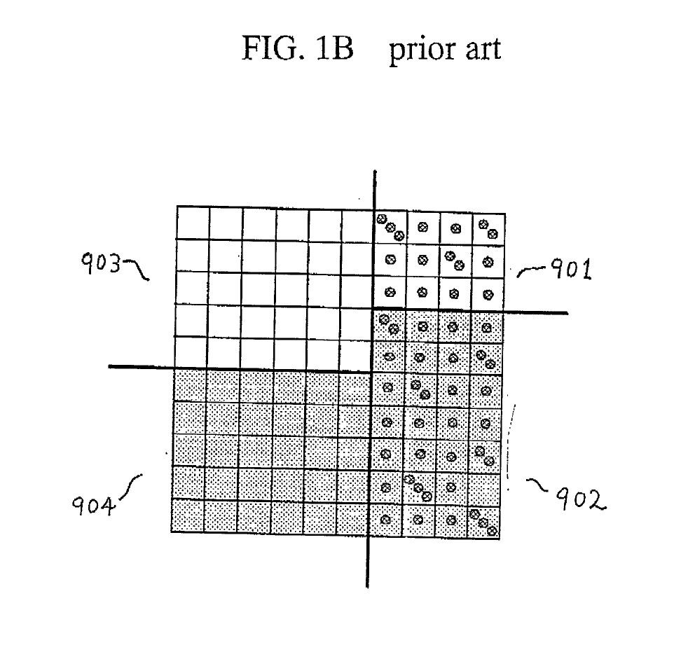

FIG. 2A is a plan view of a wafer including die-divided chips which are square-shaped in accordance with the present invention.

FIG. 2B is a plan view of sorted arrangement in view of eight species of the chips of FIG. 2A.

FIG. 3 is a block diagram of one example of computer hardware systems available to implement the above-described novel method of calculating the kill ratio, the yield and the degree of contribution to the yield by the defect of the attended type in accordance with the present invention.

FIG. 4 is a flow chart of novel operations for calculating the kill ratio of the attended defect specie in accordance with the present invention.

FIG. 5 is a flow chart of novel operations for calculating the maximum yield as the degree of contribution to the yield by respective species defects in accordance with the present invention.

FIG. 6 is a flow chart of novel operations for calculating the total yield in accordance with the present invent ion.

FIG. 7 is a flow chart of user's operation steps for obtaining the kill ratio from the die investigation data in accordance with the present invention.

FIG. 8 is a diagram of convergence of the compensated kill ratios “KRi” versus calculation time “T” or the number of calculation operation in accordance with the present invention.

FIG. 9 is a diagram of maximum yields for each of the defect species “A”, “B” and “C” in cases of the conventional method, the novel method and the use of model data in accordance with the present invention.

### DETAILED DESCRIPTION OF THE PREFERRED EMBODIMENTS

A first aspect of the present invention is a method of calculating a kill ratio of an attended defect specie, the method comprising the steps of extracting plural defect specie correspondent sets of die investigation data, and the plural defect specie correspondent sets corresponding to plural recognized defect species, and the plural recognized defect species including not only the attended defect specie but also one or more non-attended defect specie; and implementing a numerical analysis by using the extracted plural defect specie correspondent sets of die investigation data for not only the attended defect specie but also the one or more non-attended defect species, thereby to calculate a kill ratio of the attended defect specie.

It is also possible that the die investigation data include respective-specie defect number data for each defect specie and for each of the dies, and defective and non-defective indicating data for indicating defective or non-defective for each final product.

It is also possible that the step of implementing the numerical analysis comprises a step of solving simultaneous equations for kill ratios of the plural defect species including not only the attended defect specie but also the one or more non-attended defect specie.

It is also possible that the simultaneous equations are given by:

KRi=1−TGi/Σ[II{((1−KRk)ˆ Njk×((1−KRi*)ˆ (Nji−1))}]

where Σ is for “j”, II is for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” present in the final product “j” and “KRi*” is a past-calculated kill ratio.

It is also possible that an incorporation of the calculated kill ratio “KRi” into the right side term of the simultaneous equation and a subsequent operation of solving again the simultaneous equations are repeated until a degree of convergence of the calculated kill ratio “KRi” becomes within a predetermined reference value.

It is also possible that the simultaneous equations are given by:

$$\begin{matrix}KRi = 1 - TGi \times To / TGo / \sum [ Π \{ ( {( 1 - KRk )}^{⋀} Njk ) \times \\ { ( ( 1 - KRi *)}^{⋀} ( Nji - 1 ) ) \} ]\end{matrix}$$

where Σ is for “j”, II for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” present in the final product “j”, “KRi*” is an acceptable past-calculated kill ratio, “TGo” is a number of non-defective dies having the absence of the respective recognized defect species, and “To” is a number of dies having the absence of the respective recognized defect species.

It is also possible that an incorporation of the calculated kill ratio “KRi” into the right side term of the simultaneous equation and a subsequent operation of solving again the simultaneous equations are repeated until a degree of convergence of the calculated kill ratio “KRi” becomes within a predetermined reference value.

It is also possible to further comprise the steps of: extracting defect-free die investigation data of defect-free dies which are free of the respective recognized specie defects sorted from the plural defect specie correspondent sets of die investigation data; preparing compensation data which indicate an unrecognized defect specie contribution degree to the kill ratio, wherein the unrecognized defect specie contribution degree is a degree of contribution by an unrecognized defect specie other than the respective recognized specie defects, and the unrecognized defect specie is sorted based on the extracted defect-free die investigation data; and compensating the simultaneous equations with the compensation data for solving the simultaneous equations.

A second aspect of the present invention is a method of calculating a contribution degree of an attended defect specie to a total yield, the method comprising the steps of: calculating respective kill ratios of respective recognized defect species; and solving an equation given by:

“MYi”=1/T×Σ[II(1−KRk)ˆ Njk]

where “MYi” is a contribution degree of an attended defect specie “i” to the total yield, “KRk” is a respective kill ratio (of a respective recognized defect specie “k”, “T” is a total number of final products, and “Njk” is a defect number of the respective recognized defect specie “k” which is present in the final product “j” and which is other than the attended defect specie.

It is also possible that the step of calculating respective kill ratios further comprises the steps of :extracting plural defect specie correspondent sets of die investigation data, and the plural defect specie correspondent sets corresponding to plural recognized defect species, and the plural recognized defect species including not only the attended defect specie but also one or more non-attended defect specie; implementing a numerical analysis by using the extracted plural defect specie correspondent sets of die investigation data for not only the attended defect specie but also the one or more non-attended defect species, thereby to calculate a kill ratio of the attended detect specie ; and repeating the extracting and subsequent implementing steps by sequentially placing respective one of the plural recognized defect species into the, attended defect specie, thereby to calculate the respective kill ratios of respective recognized defect species.

It is also possible, that the die investigation data include respective-specie defect number data for each defect specie and for each of the dies, and defective and non-defective indicating data for indicating defective or non-defective for each final product.

It is also possible that the step of implementing the numerical analysis comprises a step of solving simultaneous equations for kill ratios of the plural defect species including not only the attended defect specie but also the one or more non-attended defect specie.

It is also possible that the simultaneous equations are given by:

KRi=1−TGi/Σ[II{((1−KRk)ˆ NJk)×((1−KRi*)ˆ (Nji−1))}]

where Σ is for “j”, II is for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” which is present in the final product “j” and which is other than the attended defect specie, and “KRi*” is an acceptable past-calculated kill ratio.

It is possible to further comprise the steps of: extracting defect-free die investigation data of defect-free dies which are free of the respective recognized specie defects sorted from the plural defect specie correspondent sets of die investigation data; preparing compensation data which indicate an unrecognized defect specie contribution degree to the kill ratio, wherein the unrecognized defect specie contribution degree is a degree of contribution by an unrecognized defect specie other than the respective recognized specie defects, and the unrecognized defect specie is sorted based on the extracted defect-free die investigation data; and compensating the simultaneous equations with the compensation data for solving the simultaneous equations.

A third aspect of the present invention is a method of calculating a contribution degree of an attended defect specie to a total yield, the method comprising the steps of: calculating respective kill ratios of respective recognized defect species; and solving an equation given by:

“MYi”=TGo/To/T×Σ[II(1−KRk)ˆ Njk]

where “MYi” is a contribution degree of an attended defect specie “i” to the total yield, “KRk” is a respective kill ratio of a respective recognized defect specie “k”, “Njk” is a defect number of the respective recognized defect specie “k” which is present in the final product “j” and which is other than the attended defect specie, “T” is a total number of final products, “TGo” is a number of non-defective dies having the absence of the respective recognized defect species, and “To” is a number of dies having the absence of the respective recognized defect species.

It is also possible that the step of calculating respective kill ratios further comprises the steps of extracting plural defect specie correspondent sets of die investigation data, aid the plural defect specie correspondent sets corresponding to plural recognized defect species, and the plural recognized defect species including not only the attended defect specie but also one or more non-attended defect specie; implementing a numerical analysis by using the extracted plural defect specie correspondent sets of die investigation data for not only the attended defect specie but also the one or more non-attended defect species, thereby to calculate a kill ratio of the attended defect specie; and repeating the extracting and subsequent implementing steps by sequentially placing respective one of the plural recognized defect species into the attended defect specie, thereby to calculate the respective kill ratios of respective recognized defect species.

It is also possible that the (lie investigation data include respective-specie defect number data for each defect specie and for each of the dies, and defective and non-defective indicating data for indicating defective or non-defective for each final product.

It is also possible that the step of implementing the numerical analysis comprises a step of solving simultaneous equations for kill ratios of the plural defect species including not only the attended defect specie but also the one Or more non-attended defect specie.

It is also possible that the simultaneous equations are given by:

$$\begin{matrix}KRi = 1 - TGi \times To / TGo / \sum [ Π \{ ( {( 1 - KRk )}^{⋀} Njk ) \times \\ { ( ( 1 - KRi *)}^{⋀} ( Nji - 1 ) ) \} ]\end{matrix}$$

where Σ is for “j”, II is for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Njk” is a defect number of the attended defect specie “i” present in a final product “j”, “Njk” is a defect number of the respective recognized defect specie “k” which is present in the final product “j” and which is other than the attended defect specie, “KRi*” is an acceptable past-calculated kill ratio, “TGo” is a number of non-defective dies having the absence of the respective recognized defect species, and “To” is a number of dies having the absence of the respective recognized defect species.

It is possible to further comprise the steps of: extracting defect-free die investigation data of defect-free dies which are free of the respective recognized specie defects sorted from the plural defect specie correspondent sets of die investigation data; preparing compensation data which indicate an unrecognized defect specie contribution degree to the kill ratio, wherein the unrecognized defect specie contribution degree is a degree of contribution by an unrecognized defect specie other than the respective recognized specie defects, and the unrecognized defect specie is sorted based on the extracted defect-free die investigation data; and compensating the simultaneous equations with the compensation data for solving the simultaneous equations.

A fourth aspect of the present invention is a method of calculating a contribution degree of an attended defect specie to a total yield, the method comprising the stops of: extracting plural defect specie correspondent sets of die investigation data, and the plural defect specie correspondent sets corresponding to plural recognized defect species, and the plural recognized defect species including not only the attended defect specie but also one or more non-attended defect specie; implementing a numerical analysis by using the extracted plural defect specie correspondent sets of die investigation data for not only the attended defect specie but also the one or more non-attended defect species, thereby to calculate a kill ratio of the attended defect specie; repeating the extracting and subsequent implementing steps by sequentially placing respective one of the plural recognized defect species into the attended defect specie, thereby to calculate the respective kill ratios of respective recognized defect species; and calculating a contribution degree of an attended defect specie to a total yield from the respective kill ratios of respective recognized defect species.

It is also possible that the die investigation data include respective-specie defect number data for each defect specie and for each of the dies, and detective and non-defective indicating data for indicating defective or non-defective for each final product.

It is also possible that the step of implementing the numerical analysis comprises a step of solving simultaneous equations for kill ratios of the plural defect species including not only the attended defect specie but also the one or more non-attended defect specie.

It is also possible that the simultaneous equations are given by:

KRi=1−TGi/Σ[II{((1−KRk)ˆ Njk)×((1−KRi*)ˆ (Nji−1))}]

where Σ is for “j”, II is for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” which is present in the final product “j” and which is other than the attended defect specie, and “KRi*” is an acceptable past-calculated kill ratio.

It is also possible that die simultaneous equations are given by:

$$\begin{matrix}KRi = 1 - TGi \times To / TGo / \sum [ Π \{ ( {( 1 - KRk )}^{⋀} Njk ) \times \\ { ( ( 1 - KRi *)}^{⋀} ( Nji - 1 ) ) \} ]\end{matrix}$$

where Σ is for “j”, II is for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” which is present in the final product “j” and which is other than the attended defect specie, “KRi*” is an acceptable past-calculated kill ratio, “TGo” is a number of non-defective dies having the absence of the respective recognized defect species, and “To” is a number of dies having the absence of the respective recognized defect species.

It is further comprise the steps of extracting defect-free die investigation data of defect-free dies which are free of the respective recognized specie defects sorted from the plural defect specie correspondent sets of die investigation data; preparing compensation data which indicate an unrecognized defect specie contribution degree to the kill ratio, wherein the unrecognized defect specie contribution degree is a degree of contribution by an unrecognized defect specie other than the respective recognized specie defects, and the unrecognized defect specie is sorted based on the extracted defect-free die investigation data; and compensating the simultaneous equations with the compensation data for solving the simultaneous equations.

A fifth aspect of the present invention is a method of calculating a yield in the absence of an attended defect specie, the method comprising the steps of extracting plural defect specie correspondent sets of die investigation data, and the plural defect specie correspondent sets corresponding to plural recognized defect species, and the plural recognized defect species including not only the attended defect specie but also one or more non-attended defect specie; implementing a numerical analysis by using the extracted plural defect specie correspondent sets of die investigation data for not only the attended defect specie but also the one or more non-attended defect species, thereby to calculate a kill ratio of the attended defect specie, repeating the extracting and subsequent implementing steps by sequentially placing respective one of the plural recognized defect species into the attended defect specie, thereby to calculate the respective kill ratios of respective recognized defect species and calculating a yield in the absence of the attended defect specie by use of the respective kill ratios and respective numbers of non-attended defect species of respective recognized defect species for each die.

It is also possible that the die investigation data include respective-specie defect number data for each defect specie and for each of the dies, and defective and non-defective indicating data for indicating defective or non-defective for each final product.

It is also possible that the step of implementing the numerical analysis comprises a step of solving simultaneous equations for kill ratios of the plural defect species including not only the attended defect specie but also the one or more non-attended defect specie.

It is possible to further comprise the steps of: extracting defect-free die investigation data of defect-free dies which are free of the respective recognized specie defects sorted from the plural defect specie correspondent sets of die investigation data; preparing compensation data which indicate an unrecognized defect specie contribution degree to the kill ratio, wherein the unrecognized defect specie contribution degree is a degree of contribution by an unrecognized defect specie other than the respective recognized specie defects, and the unrecognized defect specie is sorted based on the extracted defect-free die investigation data; and compensating the simultaneous equations with the compensation data for solving the simultaneous equations.

A sixth aspect of tho present invention is a method of calculating a total yield, the method comprising the steps of: calculating respective kill ratios of respective recognized defect species; and solving an equation given by:

“Y”=1/×Σ[II(1−KRk)ˆ Njk]

where “Y” is a total yield, “KRk” is a respective kill ratio of a respective recognized defect specie “k”, “T” is a total number of final products, and “Njk” is a defect number of the respective recognized defect specie “k” which is present in the final product “j”.

It is also possible that the step of calculating respective kill ratios further comprises the steps of: extracting plural defect specie correspondent sets of die investigation data, and the plural defect specie correspondent sets corresponding to plural recognized defect species, and the plural recognized defect species including not only the attended defect specie but also one or more non-attended defect specie; implementing a numerical analysis by using the extracted plural defect specie correspondent sets of die investigation data for not only the attended defect specie but also the one or more non-attended defect species, thereby to calculate a kill ratio of the attended defect specie; and repeating the extracting and subsequent implementing steps by sequentially placing respective one of the plural recognized defect species into the attended defect specie, thereby to calculate the respective kill ratios of respective recognized defect species.

It is also possible that the die investigation data include respective-specie defect number data for each defect specie and for each of the dies, and defective and non-defective indicating data for indicating defective or non-defective for each final product.

It is also possible that the step of implementing the numerical analysis comprises a step of solving simultaneous equations for kill ratios of the plural defect species including not only the attended defect specie but also the one or more non-attended defect specie.

It is also possible that the simultaneous equations are given by:

KRi=1−TGi/Σ[II{((1−KRk)ˆ Njk)×((1−KRi*)ˆ (Nji−1))}]

where Σ is for “j”, II is for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” which is present in the final product “j” and which is other than the attended defect specie, and “KRi*” is an acceptable past-calculated kill ratio.

It is also possible to further comprise the steps of: extracting defect-free die investigation data of defect-free dies which are free of the respective recognized specie defects sorted from the plural defect specie correspondent sets of die investigation data; preparing compensation data which indicate an unrecognized defect specie contribution degree to the kill ratio, wherein the unrecognized defect specie contribution degree is a degree of contribution by an unrecognized defect specie other than the respective recognized specie defects, and the unrecognized defect specie is sorted based on the extracted defect-free die investigation data; and compensating the simultaneous equations with the compensation data for solving the simultaneous equations.

A seventh aspect of the present invention is a method of calculating a total yield, the method comprising the steps of: calculating respective kill ratios of respective recognized defect species; and solving an equation given by:

“Y”=TGo/To/T×Σ[II(1−KRk)ˆ Njk]

where “Y” is a total yield, “KRk” is a respective kill ratio of a respective recognized defect specie “k”, “Njk” is a defect number of the respective recognized defect specie “k” which is present in the final product “j”, “T” is a total umber of final products, “TGo” is a number of non-defective dies having the absence of the respective recognized defect species, and “To” is a number of dies having the absence of the respective recognized defect species.

It is also possible that the step of calculating respective kill ratios further comprises the steps of: extracting plural defect specie correspondent sets of die investigation data, and the plural defect specie correspondent sets corresponding to plural recognized defect species, and the plural recognized defect species including not only the attended defect specie but also one or more non-attended defect specie implementing a numerical analysis by using the extracted plural defect specie correspondent sets of die investigation data for not only the attended defect specie but also the one or more non-attended defect species, thereby to calculate a kill ratio of the attended defect specie; and repeating the extracting and subsequent implementing steps by sequentially placing respective one of the plural recognized defect species into the attended defect specie, thereby to calculate the respective kill ratios of respective recognized defect species.

It is also possible that the die investigation data include respective-specie defect number data for each defect specie and for each of the dies, and defective and non-defective indicating data for indicating defective or non-defective for each final product.

It is also possible that the step of implementing the numerical analysis comprises a step of solving simultaneous equations for kill ratios of the plural defect species including not only the attended defect specie but also the one or more non-attended defect specie.

It is also possible that the simultaneous equations are given by:

$$\begin{matrix}KRi = 1 - TGi \times To / TGo / \sum [ Π \{ ( {( 1 - KRk )}^{⋀} Njk ) \times \\ { ( ( 1 - KRi *)}^{⋀} ( Nji - 1 ) ) \} ]\end{matrix}$$

where Σ is for “j”, II is for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” which is present in the final product “j” and which is other than the attended defect specie, “KRi*” is an acceptable past-calculated kill ratio, “TGi” is a number of non-defective dies having the absence of the respective recognized defect species, and “To” is a number of dies having the absence of the respective recognized defect species.

It is also possible to further comprise the steps of: extracting defect-free die investigation data of defect-free dies which are free of the respective recognized specie defects sorted from the plural defect specie correspondent sets of die investigation data; preparing compensation data which indicate an unrecognized defect specie contribution degree to the kill ratio, wherein the unrecognized defect specie contribution degree is a degree of contribution by an unrecognized defect specie other than the respective recognized specie defects, and the unrecognized defect specie is sorted based on the extracted defect-free die investigation data; and compensating the simultaneous equations with the compensation data for solving the simultaneous equations.

An eighth aspect of the present invention is a method of calculating a total yield, the method comprising the steps of: extracting plural defect specie correspondent sets of die investigation data, and the plural defect specie correspondent sets corresponding to plural recognized defect species, and the plural recognized defect species including not only the attended defect specie but also one or more non-attended defect specie; implementing a numerical analysis by using the extracted plural defect specie correspondent sets of die investigation data for not only the attended defect specie but also die one or more non-attended defect species, thereby to calculate a kill ratio of the attended defect specie; repeating the extracting and subsequent implementing steps by sequentially placing respective one of the plural recognized defect species into the attended defect specie, thereby to calculate the respective kill ratios of respective recognized defect species; and calculating a total yield from the respective kill ratios of respective recognized defect species.

It is also possible that the die investigation data include respective-specie defect number data for each defect specie and for each of the dies, and defective and non-defective indicating data for indicating defective or non-defective for each final product.

It is also possible that the step of implementing the numerical analysis comprises a step of solving simultaneous equations for kill ratios of the plural defect species including not only the attended defect specie but also the one or more non-attended defect specie.

It is also possible that the simultaneous equations are given by:

KRi=1−TGi/Σ[II{((1−KRk)ˆ Njk)×((1−KRi*)ˆ (Nji−1))}]

where Σ is for, “j”, II for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” which is present in the final product “j” and which is other than the attended defect specie, and “KRi*” is all acceptable past-calculated kill ratio.

It is also possible that the simultaneous equations are given by:

$$\begin{matrix}KRi = 1 - TGi \times To / TGo / \sum [ Π \{ ( {( 1 - KRk )}^{⋀} Njk ) \times \\ { ( ( 1 - KRi *)}^{⋀} ( Nji - 1 ) ) \} ]\end{matrix}$$

where Σ is for “j”, II for “k”, “KRi” is a dill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in a final product “j”, “Njk” is a defect number of the respective recognized defect specie “k” which is present in the final product “j” and which is other than the attended defect specie, “KRi*” is an acceptable past-calculated kill ratio, “TGo” is a number of non-defective dies having the absence of the respective recognized defect species, and “To” is a number of dies having the absence of the respective recognized defect species.

It is possible to further comprise the steps of: extracting defect-free die investigation data of defect-free dies which are free of the respective recognized specie defects sorted from the plural defect specie correspondent sets of die investigation data; preparing compensation data which indicate an unrecognized defect specie contribution degree to the kill ratio, wherein the unrecognized defect specie contribution degree is a degree of contribution by an unrecognized defect specie other than the respective recognized specie defects, and the unrecognized defect specie is sorted based on the extracted defect-free die investigation data and compensating the simultaneous equations with the compensation data for solving the simultaneous equations.

In accordance with the present invention, the analysis and estimation of the yield of the IC chips as final product are made as follows. In consideration of clusterization of recognized or monitored defects in plane of wafer or deviation of distribution of the defects, an estimation of a device kill ratio of the recognized or monitored defects is made. The device kill ratio is a probability of defective of the device or final product. From the obtained kill ratio, the factors of causing the device defective and the device yield are estimated.

A probability of non-defective of the chips in the presence of respective recognized or monitored defects on dies is previously estimated to prepare an equation for finding a kill ratio of defects of an attended specie. For all of the defect species, respective equations for finding respective kill ratios of defects of respective specie are prepared. The equations of the same number as the defect specie number are thus prepared. Those equations are in the form of simultaneous equations. The simultaneous equations are solved to find the kill ratios of the defects of the respective species. From the found kill ratios, the factor of the defective of the devices arc estimated. Further, the yield is estimated from both the kill ratios of the respective defect species and the defect distribution data.

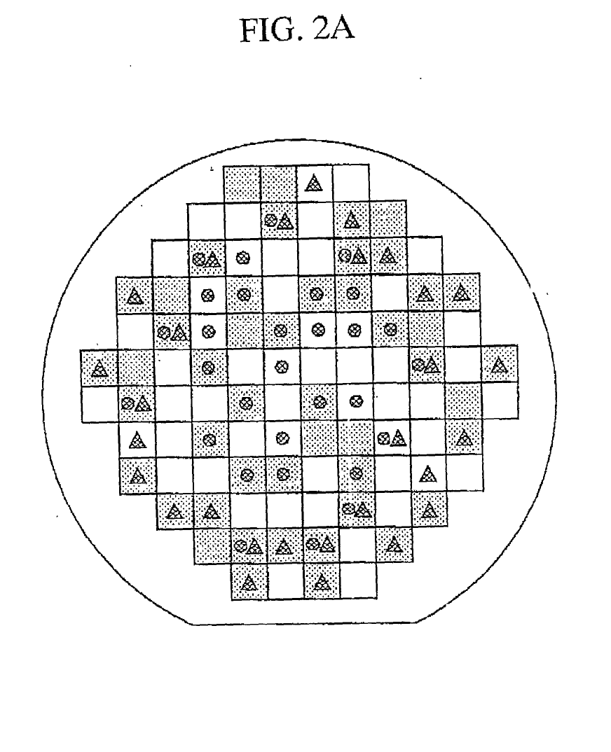

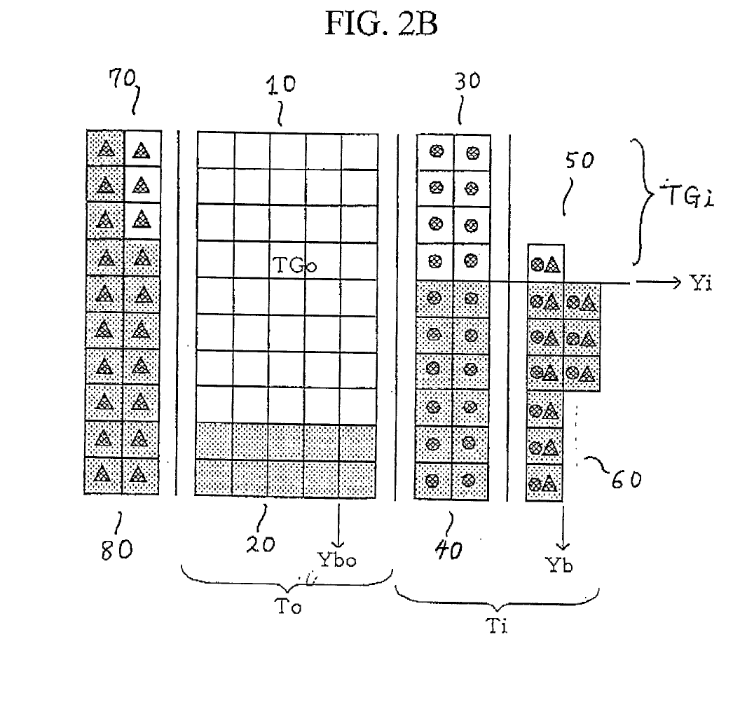

FIG. 2A is a plan view of a wafer including die-divided chips which arc square-shaped. FIG. 2B is a plain view of sorted arrangement in view of eight types of the chips of FIG. 2A. White color squares represent non-defective chips. Gray color squares represent defective chips, Cross-hatched circles represent attended specie defects. Cross-hatched triangles represent non-attended specie defects which will also be referred to as other recognized or monitored defects. The chips may be classified into the following eight types.

A first type chip 10 is represented by a white color square free of cross-hatched circle and cross-hatched triangle, wherein the first type chip 10 is defect-free non-defective chip.

A second type chip 20 is represented by a gray color square free of cross-hatched circle and cross-hatched triangle, wherein the second type chip 20 is defect-free defective chip.

A third type chip 30 is represented by a white color square containing cross-hatched circle and free of cross-hatched triangle, wherein the third type chip 30 is attended-defect-containing non-defective chip.

A fourth type chip 40 is represented by a gray color square containing cross-hatched circle and free of cross-hatched triangle, wherein the fourth type chip 40 is attended-defect-containing defective chip.

A fifth type chip 50 is represented by a white color square containing both cross-hatched circle and cross-hatched triangle, wherein the fifth type chip 50 is attended-defect and non-attended-defect containing non-defective chip.

A sixth type chip 60 is represented by a gray color square containing both cross-hatched circle and cross-hatched triangle, wherein the sixth type chip 60 is attended-defect and non-attended-defect containing defective chip.

A seventh type chip 70 is represented by a white color square free of cross-hatched circle and containing cross-hatched triangle, wherein the seventh type chip 70 is non-attended-defect containing non-defective chip.

An eighth type chip 80 is represented by a gray color square free of cross-hatched circle and containing cross-hatched triangle, wherein the eighth type chip 80 is non-attended-defect containing defective chip.

The yield “Yi” of the chips containing the attended defects, for the third, fourth, fifth and sixth types chips is given by

Yi=SRi×Yb (1)

where “SRi” is a survive ratio of an attended chip if containing a single defect of the attended specie “i”, and “Yb” is a yield (base line yield) of this chip if containing not only the single defect of the attended specie “i”, but also one or more other defects, wherein the other defects may be of either the attended specie or non-attended specie.

The yield “Yi” is also represented by the following equation.

Yi=TGi/Ti (2)

where “TGi” is a number of non-defective chips which contain the attended specie defects “i”, and “Ti” is a total number of defective and non-defective chips which contain the attended specie defects “i”.

If the base line yield “Yb” could be found, then the survive ratio “SRi” of the attended chip having the single defect of the attended specie “i” could be found from the above equations (1) and (2).

The base line yield “Yb” may be estimated as the quotient obtained by dividing the cumulated survive ratios of the respective chips “j”, which contain the attended-specie defects “i”, with the number “Ti” of the chips containing the attended specie defects “i”. The survive ratio “SRi” of the respective recognized or monitored defect “k” is given by:

Yb=Σ(IISRkˆ Njk)/Ti (3)

where the product is for “k” and the sum is for “j”, and “Njk” is a number of the other defects “k” than the single defect of the attended specie “i”, wherein “Njk” is smaller by one than the total number of the chips containing the attended specie defects “i”.

From the above equations. (1), (2) and (3), the survive ratio “SRi” of the non-defective chips containing the attended specie defects “i” is given by:

SRi=TGi/Σ(IISRkˆ Njk) (4)

The above equation (4) is present for respective species of the defects. If the number of the defect species; is “M”, then the simultaneous equations of the number “M” are present, and may be solved for numeral analysis. The survive ratio “SRi” of the non-defective chips containing the attended specie defects may be found by solving the simultaneous equations.

The kill ratio “KRi” of the (defective chips containing the attended specie defects is given by:

KRi=1−SRi.

The above equation (4) may be re-written by use of the equation (KRi=1−SRi) as follows.

1−KRi=TGi/Σ(II(1−KRk)ˆ Njk)) (4′)

The equation (4′) may further be rewritten as follows.

KRi=1−TGi/Σ(II(1−KRk)ˆ Njk)) (5)

The right term “(1−KRk)ˆ Njk” includes the case of presence of two or more defects of the attended specie “i”.

This term is divided into a term for the attended specie defect “i” and another term for the other recognized or monitored defect “k”, and the equation (5) may be re-written as follows.

$$\begin{matrix}KRi = 1 - TGi / \sum [ Π \{ ( {( 1 - KRk )}^{⋀} Njk ) \times \\ ( {( 1 - KRi )}^{ \hat{}} ( Nji - 1 ) ) \} ]\end{matrix} \qquad ( 6 )$$

where the product is for “k” and the sum is for “j”, “Njk” is a number of the defect of the other specie “k” present in the chip “j”, and “Nji” is a number of the defect of the attended specie “i”.

The above equation (6) does not consider the “defectiveness” due to the unrecognized or non-monitored defects, because the base line yield “Yb” is the yield of the chips containing the single defect of the attended-specie due to the other monitored defects than the single defect of the attended-specie. Actually, however, the base line yield “Yb” is influenced by the unrecognized or non-monitored defects. For this reason, it is necessary to compensate the base line yield “Yb” by eliminating the influence due to the unrecognized or non-monitored defects.

It is, hereby, assumed that non-monitored defects are uniformly distributed over the wafer. The yield “Ybo” of the chip containing not only the attended specie defect “i” but also the non-monitored defect is predictable from the yield of the chip free of the monitored defects. The yield “Ybo” is given by:

Ybo=TGo/To (7)

where “To” is a number of the chips free of the monitored defects, and “TGo” is a number of the non-defective chips free of the monitored defects. The above base line yield may be compensated by use of the equation (7). The compensated base line yield “Ybc” is given by:

$$\begin{matrix}Ybc = Ybo \times Yb \\ = Ybo \times TGo / To\end{matrix} \qquad ( 8 )$$

where “Yb” is the uncompensated base line yield.

The above equation (6) may further be re-written as follows by use of the compensated base line yield “Ybc*”.

$$\begin{matrix}KRi = 1 - TGi \times To / TGo / \sum [ \prod \{ ( {( 1 - KRk )}^{ \hat{}} Njk ) \times \\ ( {( 1 - KRi )}^{ \hat{}} ( Nji - 1 ) ) \} ]\end{matrix} \qquad ( 9 )$$

Accordingly, the uncompensated kill ratio of the non-defective chips in the presence of the attended specie defect is given by the above equation (6) without consideration of the contribution to the yield by the unrecognized or non-monitored defects.

The compensated kill ratio of the non-defective chips in the presence of the attended specie defect is given by the above equation (9), wherein the yield is compensated in consideration of the contribution to the yield by the unrecognized or non-monitored defects.

Further, the degree of the contribution to the yield by the defects of the attended specie “i” may be calculated based on the respective kill ratio “KRk” and a number “Njk” of the other defects “k” than the single defect of the attended specie “i”, wherein “Njk” is smaller by one than the total number of the chips containing the attended specie defects “i”.

The degree of the contribution to the yield by the defects of the attended specie “i” may be estimated based on the yield in the absence of the attended specie defects “i” and in the presence of the other defects. This yield in the absence of the attended specie defects “i” and in the presence of the other defects is calculated from the respective kill ratios of the respective species defects.

Without consideration of the contribution to the yield by the unrecognized or non-monitored defects, the degree “MYi” of the contribution to the yield by the defects of the attended specie “i” is given by:

MYi=1/T×Σ[II(1−KRk)ˆ Njk] (10)

where “MYi” is a contribution degree of an attended defect specie “i” to the total yield, “KRk” is a respective kill ratio of a respective recognized defect specie “k”, “T” is a total number of final products, and “Njk” is a defect number of said respective recognized defect specie “k” which is present in said final product “j” and which is other than said attended defect specie.

From the equation (10), the degree “MYi” of the contribution to the yield by the defects of the attended specie “i” may be calculated, in the absence of consideration of the contribution to the yield by the unrecognized or non-monitored defects.

Furthermore, the total yield by the defects of the attended specie “i” may be calculated based on the respective kill ratio “KRk” and the number “Njk” of the other defects “k” than the single defect of the attended specie “i”, wherein “Njk” is smaller by one than the total number of the chips containing the attended specie defects “i”.

Without consideration of the contribution to the yield by the unrecognized or non-monitored defects, the total yield “i” by the defects of the attended specie “i” is given by:

Y=1/T×Σ[II(1−KRk)ˆ Njk] (11)

where “MYi” is a contribution degree of an attended defect specie “i” to the total yield, “KRk” is a respective kill ratio of a respective recognized defect specie “k”, “T” is a total number of final products, and “Njk” is a defect number of the respective recognized defect specie “k” which is present in the final product “j” and which is other than said attended defect specie.

From the equation (11), the total yield “Y” by the defects of the attended specie “i” may be calculated, in the absence of consideration of the contribution to the yield by the unrecognized or non-monitored defects.

In consideration of the contribution to the yield by the unrecognized or non-monitored defects, the degree “MYi” of the contribution to the yield by the defects of the attended specie “i” is given by:

MYi=TGo/To/T×Σ[II(1−KRk)ˆ Njk] (12)

where “MYi” is a contribution degree of an attended defect specie “i” to the total yield, “k” is a respective kill ratio of a respective recognized defect specie “k”, “T” is a total number of final products, and “Njk” is a defect number of said respective recognized defect specie “k” which is present in said final product “j” and which is other than said attended defect specie, and “TGo” is a number of non-defective dies having the absence of the respective recognized defect species, and “To” is a number of dies having the absence of the respective recognized defect species.

From the equation (12), the degree “MYi” of the contribution to the yield by the defects of the attended specie “i” may be calculated, in consideration of the contribution to the yield by the unrecognized or non-monitored defects.

Furthermore, the total yield by the defects of the attended specie “i” may be calculated based on the respective kill ratio “KRk” and the number “Njk” of the other defects “k” than the single defect of the attended specie “i”, wherein “Njk” is smaller by one than the total number of the chips containing the attended specie defects “i”.

In consideration of the contribution to the yield by the unrecognized or non-monitored defects, the total yield “i” by the defects of the attended specie “i” is given by:

Y=TGo/To/T×Σ[II(1−KRk)ˆ Njk] (13)

where “MYi” is a contribution degree of an attended defect specie “i” to the total yield, “KRk” is a respective kill ratio of a respective recognized defect specie “k”, “T” is a total number of final products, and “Njk” is a defect number of the respective recognized defect specie “k” which is present in the final product “j” and which is other than said attended defect specie, and “TGo” is a number of non-defective dies having the absence of the respective recognized defect species, and “To” is a number of dies having the absence of the respective recognized defect species.

From the equation (13), the total yield “Y” by the defects of the attended specie “i” may be calculated, in consideration of the contribution to the yield by the unrecognized or non-monitored defects.

The kill ratio is calculated reflective to the contribution by the respective numbers of the respective species defects present in the each die, for which reasons a highly accurate calculation of the kill ratio is obtained even if the plural defects of the attended single specie are present in the single die or if the distributions of the respective species defects are non-uniform.

The kill ratio is compensated by the compensation data which reflect to the contribution by the other defects than the attended specie defects. The kill ratio is reflective to the number of the attended specie defects but free from any influence or contribution by the other species defects, for which reason a highly accurate calculation of the kill ratio is obtained.

The above-described novel methods of calculating the kill ratios, the yield, and the degree of contribution to the yield by the defect of the attended type may be realized by computer programs which may, for example, be executed in the known computer system, without introducing any novel computer hardware.

For implementing the above-described novel methods, the computer programs may be stored in any of available storage mediums such as ROM, HDD (hard disc drive), CD-ROM, and FD.

The available computer system may be a device system of reading the computer programs and implementing operations in accordance with the computer programs. The system may include CPU, ROM, or RAM and I/F and other peripheral devices.

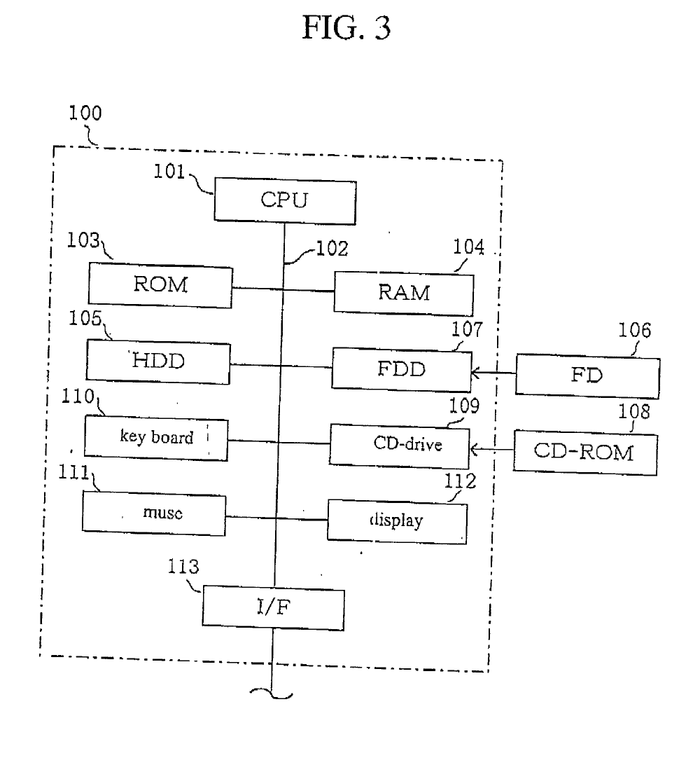

A preferred embodiment according to the present invention will be described in detail with reference to the drawings. FIG. 3 is a block diagram of one example of computer hardware systems available to implement the above-described novel method of calculating the kill ratio, the yield and the degree of contribution to the yield by the defect of the attended type.

The computer hardware system may include a data processor 100, a floppy disk FD 106 and a CD-ROM 108 The data processor 100 may be realized by a personal computer. The data processor 100 may include a CPU 101, a bus line 102 connected to the CPU 101, a ROM 103 connected to the bus line 102, a RAM 104 connected to the bus line 102, a HDD 105 connected to the bus line 102, a floppy disk drive (FDD) 107 connected to the bus line 102 for driving the floppy disk FD 106, a CD-drive 109 connected to the bus line 102 for driving the CD-ROM 108, a key board 110 connected to the bus line 102, a mouse 111 connected to the bus line 102, a display 112 connected to the bus line 102, and an interface 113 connected to the bus line 102. The ROM 103, the RAM 104, the HDD 105, the FD 106, and the CD-ROM 108 serve as storage mediums for storing data and computer programs as software for implementing the novel method.

Control programs for implementing the operations by the CPU 101 may previously be stored in the FD 106 and the CD-ROM 108 The software may previously be installed in the HDD 105, so that, in starting the computer, the necessary computer programs of the software may be copied to the RAM 104 and then read by the CPU 101, whereby the CPU 101 implements the operations in accordance with the computer programs.

The above-described warfare system is one example of the computer systems available to implement the above-described novel method. The available system may also be considered to be an integration of functional devices as follows.

The data processor 100 may logically be realized to include a data storage means 211, a data input moans 212, a data retrieval means 213, a first data extraction means 214, a kill ratio calculation means 215, a maximum yield calculation means 222, a total yield calculation means 223.

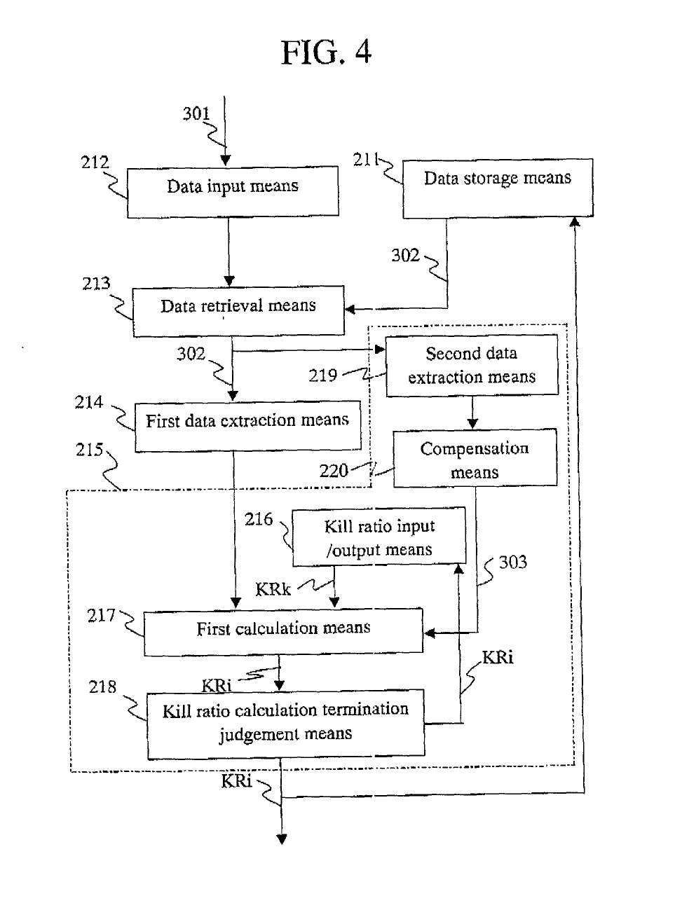

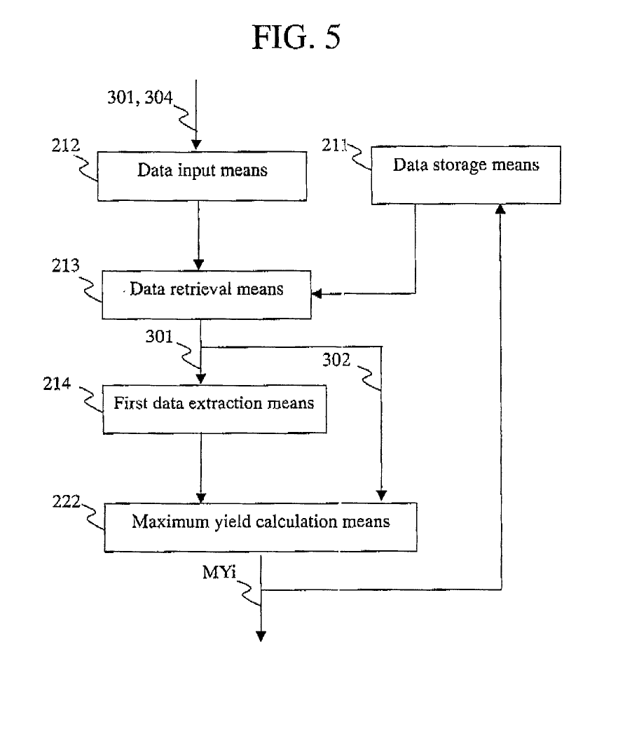

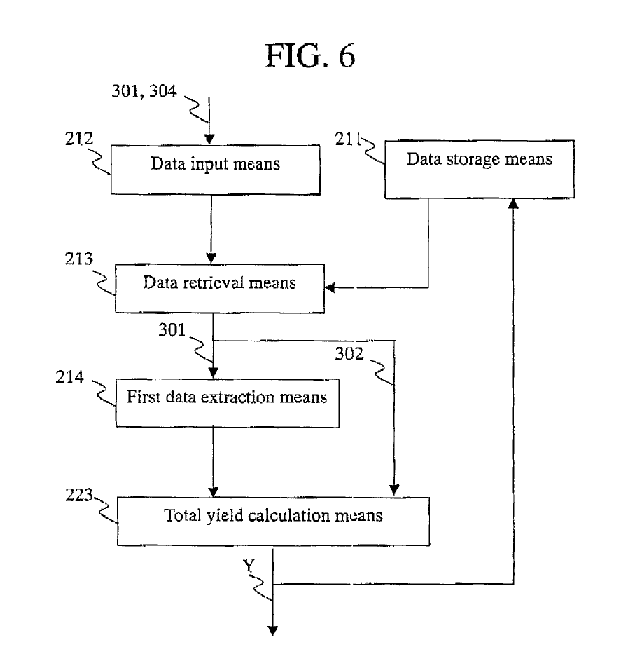

FIG. 4 is a flow chart of novel operations for calculating the kill ratio of the attended defect specie. FIG. 5 is a flow chart of novel operations for calculating the maximum yield as the degree of contribution to the yield by respective species defects. FIG. 6 is a flow chart of novel operations for calculating the total yield.

The data storage means 211 corresponds to a storage function means which may include the above storage mediums such as HDD 105, RAM 104, ROM 103, FDD 107, and CD-drive 109. The data storage means 211 previously store a large number of die investigation data 302 and store calculated kill ratios and the maximum yields as the degree of contribution to the yield by respective species defects. The die investigation data 302 include respective informations associated with each of the dies of the wafer. The respective informations may at least include respective numbers of the defects of the respective species for each die, and defectiveness and non-defectiveness for each die,

Actually, the die investigation data are hierarchically stored in classification with the respective processes for manufacturing the semiconductor integrated circuits, with each of the semiconductor wafers including plural dies, and with each lot including the plural semiconductor wafers. The calculated kill ratios may be stored in classification with the respective species of the defects. The calculated maximum yields as the degree of contribution to the yield by respective species defects may be stored in classification with the respective species of the defects.

The data input means 212 corresponds to functions of data input and recognition of the input data. One example of the function of data input is the key board 110. One example of the function of the input data recognition is the CPU 101. The input data may include species selection data for selecting an attended specie defect, die investigation data selection data 301, kill ratio data selection data 304 for selecting one of groups of the kill ratio data for respective defect species, and maximum yield data selection data for selecting one of the groups of the maximum yield data for respective defect species.

The first data extraction means 214 corresponds to a function of the CPU 101, wherein the function may be realized by the control program temporary stored in the RAM 104. The first data extraction means 214 extracts the die investigation data which corresponds to the attended species defects from the data storage means 211.

The kill ratio calculation means 215 corresponds to another function of the CPU 101, wherein the other function may be realized by the control program temporary stored in the RAM 104. The kill ratio calculation means 215 calculates the kill ratio “KRi” of the attended specie defect “i” from the extracted die investigation data.

The kill ratio calculation means 215 may, for example, be realized to include a kill ratio input/output means 216, a first calculation means 217, a kill ratio calculation termination judgement means 218, a second data extraction means 219 and a compensation means 220.

The first calculation means 217 is connected to the first data extraction means 214 for receiving the extracted die investigation data for the respective defect species from the first data extraction means 214 and also receiving respective initial kill ratios of the respective defect species from the kill ratio input/output means 216, so that the first calculation means 217 calculates a kill ratio of each defect specie based on the die investigation data and the respective initial kill ratios.

The kill ratio input/output means 216 stores binary digit data “0” or “1” which indicate the initial kill ratios of all defect species. The kill ratio input/output means 216 transmits the initial kill ratios of all defect species to the first calculation means 217. The first calculation means 217 calculates a kill ratio of each defect specie based on the die investigation data and the respective initial kill ratios. The kill ratio input/output means 216 further stores the calculated respective kill ratios outputted from the kill ratio calculation termination judgement means 218. The kill ratio input/output means 216 transmits the calculated respective kill ratios to the first calculation means 217.

The second data extraction means 219 extracts the die investigation data associated with detected-defect free dies from the die investigation data retrieved by the data retrieval means 213.

The compensation means 220 is connected to the second data extraction means 219 for receiving the extracted die investigation data from the second data extraction means 219, so that the compensation means 220 generates compensation data 303 which reflects the contribution to the yield by the non-detected defects. The compensation means 220 transmits the compensation data to the first calculation means 217, so that the first calculation means 217 incorporates the compensation data into the kill ratios to calculate the compensated kill ratios “KRj” of the respective defect species. The first calculation means 217 transmits the compensated kill ratios “KRj” to the kill ratio calculation termination judgement means 218.

The needs to operate the second data extraction means 219 and the compensation means 220 are depend on the extracted die investigation data. The kill ratio calculation termination judgement means 218 compares a degree of convergence of the calculated kill ratios of the defects of the respective species to a predetermined reference value. If the degree of convergence is above the predetermined reference value, then the kill ratio calculation termination judgement means 218 transmits the kill ratios of the defects of the respective species to the kill ratio input/output means 216. If the degree of convergence is below the predetermined reference value, then the kill ratio calculation termination judgement means 218 transmits the kill ratio “KRi” of the each defect specie “i” to the data storage means 211 and further to the display 112.

The above kill ratio input/output means 216, the first calculation means 217, the kill ratio calculation termination judgement means 218, the second data extraction means 219 and the compensation means 220 are realized by the respective functions of the CPU 101. The respective operations may be made in sequential processes.

The kill ratio calculation means 215 calculates the kill ratio “KRi” of the each defect specie “i” by solving the following equation.

$$\begin{matrix}KRi = 1 - TGi \times To / TGo / \sum [ \prod \{ ( {( 1 - KRk )}^{ \hat{}} Njk ) \times \\ ( {( 1 - KRi )}^{ \hat{}} ( Nji - 1 ) ) \} ]\end{matrix}$$

where Σ is for “j”, II is for “k”, “KRi” is a kill ratio of the attended defect specie “i”, “TGi” is a number of non-defective dies having the presence of the attended defect specie “i”, “KRk” is a respective kill ratio of a respective recognized defect specie “k”, “Nji” is a defect number of the attended defect specie “i” present in the chip “j” as the final product, “Njk” is a defect number of the respective recognized defect specie “k” present in the final product “j”, “KRi” is an acceptable past-calculated kill ratio, “To” is a number of non-defective dies having the absence of the respective recognized defect species, and “To” is a number of dies having the absence of the respective recognized defect species.

The operations by the CPU 101 may be implemented in accordance with the computer soft ware stored in the storage medium. The die investigation data are entered from the input device such as the key board 110 and then stored in a predetermined format into the storage medium such as the HDD 105, thereby constructing a data base. The defect species selection data are entered from the input device such as the key board 110. The die investigation data ire retrieved from the storage medium such as the HDD 105 in accordance with the defect species selection data. The retrieved die investigation data are then classified into respective groups belonging to the respective defect species. From the classified die investigation data, there arc detected the number “TGi” of non-defective dies having the presence of the attended defect specie “i”, the defect number “Njk” of the respective recognized defect specie “k” present in the final product “j”, the respective kill ratio “KRk” of the respective recognized defect specie “k”, the defect number “Nji” of the attended defect specie “i” present in the chip “j” as the final product, the acceptable past-calculated kill ratio “KRi*”, the number “TGo” of non-defective dies having the absence of the respective recognized defect species, and the number “To” of dies having the absence of the respective recognized defect species.

The kill ratio “KRi” for the attended specie defects is calculated in accordance with the following equations,

$$\begin{matrix}KRi = 1 - TGi \times To / TGo / \sum [ Π \{ ( ( 1 - KRk ) \hat{} Njk ) \times \\ ( ( 1 - KRi *) \hat{} ( Nji - 1 ) ) \} ]\end{matrix}$$

The degree of convergence of the calculated kill ratios of the attended specie defects is then compared to the predetermined reference value. If the degree of convergence is above the predetermined reference value, then the calculated kill ratio is used for again calculation of the kill ratio. If the degree of convergence is below the predetermined reference value, then the calculated kill ratio is transmitted to the data storage means and also to the display device 112 for data output.

The control programs for allowing the CPU 101 to execute the above operations may be stored in the RAM 104.

The novel methods of analysis to the yield and of estimating the yield of the integrated circuit chips may be implemented by use of the computer hardware system and the storage mediums.

User of the data processor 100 uses a non-illustrated circuit manufacturing system to form integrated circuits in the respective dies of the wafer. In each of the manufacturing processes, a non-illustrated defect checker is used to investigate the respective numbers of the defects for respective defect species in each of the dies, The defect checker is also used to check the defectiveness or the non-defectiveness of each of the IC chips as the final product, thereby producing the die investigation data which include at least the respective numbers of the defects for respective defect species in each of the dies and the defectiveness or the non-defectiveness of each of the IC chips as the final product. The die investigation data are then stored in the data storage means such as the HDD 105 of the data processor 100.

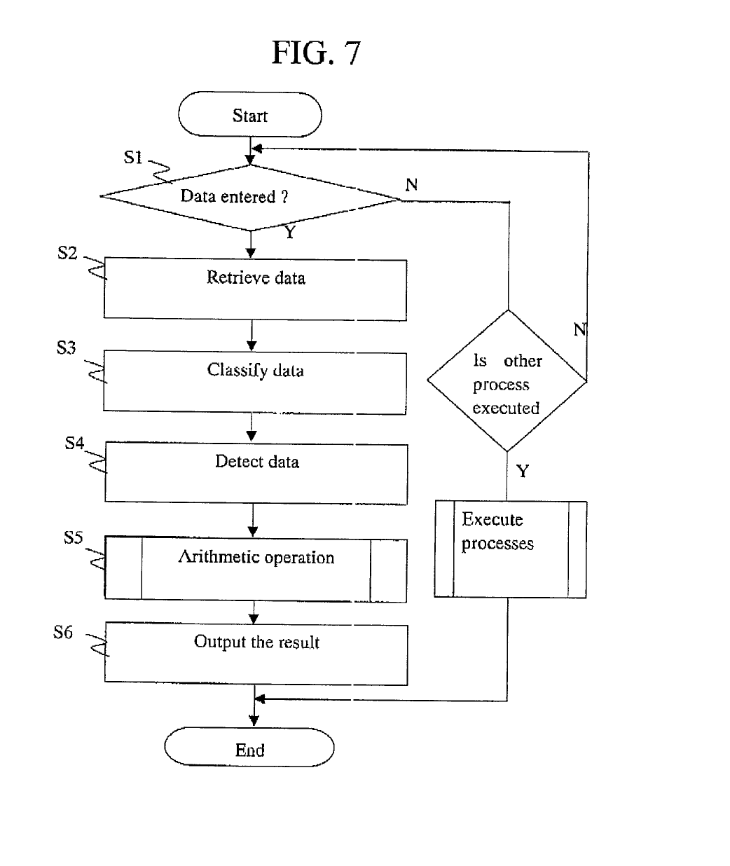

The user may calculate the kill ratios from the die investigation data. FIG. 7 is a flow chart of user's operation steps for obtaining the kill ratio from the die investigation data.

In a step S1, the user operates the key board 110 to enter the selected die investigation data selection data into the data processor 100.

In a step S2, the data processor 100 retrieves a corresponding one of the die investigation data to the entered die investigation data selection data from the storage means such as the HDD 105.

In a step S3, the first data extraction means 214 extracts the retrieved die investigation data and classifies the extracted die investigation data into respective groups belonging to dies having the presence of the respective species defects.

In a step S4, the first calculating means 217 of the kill ratio calculation means 215 receives the classified die investigation data and detects therefrom the number “TGi” of non-defective dies having the presence of the attended defect specie “i”, the defect number “Njk” of the respective recognized defect specie “k” present in the final product “j”, the respective kill ratio “KRk” of the respective recognized defect specie “k”, the defect number “Nji” of the attended defect specie “i” present in the chip “j” as the final product, the acceptable past-calculated kill ratio “KRi*”, the number “TGo” of non-defective dies having the absence of the respective recognized defect species, and the number “To” of dies having the absence of the respective recognized defect species.

In a step S5, the first calculating means 217 of the kill ratio calculation means 215 prepares the following simultaneous equations and solves the same to calculate the kill ratio “KRi” of the attended specie defect “i”.

$$\begin{matrix}KRi = 1 - TGi \times To / TGo / \sum [ Π \{ ( ( 1 - KRk ) \hat{} Njk ) \times \\ ( ( 1 - KRi *) \hat{} ( Nji - 1 ) ) \} ]\end{matrix}$$

The above detected values are incorporated into the right side terms of the above simultaneous equations to calculate the respective kill ratios “KRk”. The past-calculated respective kill ratio “KRk” and the extracted die investigation data arc again incorporated into the right side terms of the above simultaneous equations to calculate the kill ratio “KRi” of the attended specie defects. Those operations are repeated until the degree of convergence of the calculated kill ratio “KRi” is within the reference value. After the degree of convergence of the calculated kill ratio “KRi” is within the reference value, then the calculation operations are then terminated.

In a step S6, the result of the calculation is then displayed by the display device 112.

A prototype data processor 100 was prepared to have investigated the accuracy of calculating the kill ratio “KRi” by use of modeled die investigation data.

TABLE 1

| | defect number | kill-defect number | kill ratio |
|---|---|---|---|
| Defect species | Ni | Nfi | Nfi/Ni |
| “A” | 400/10 wafers | 280/10 wafers | 0.7 |
| “B” | 400/10 wafers | 200/10 wafers | 0.5 |
| “C” | 700/10 wafers | 140/10 wafers | 0.2 |

The used model die investigation data were prepared, wherein a single wafer was divided into 200 dies. Defects of three species “A”, “B”, and “C” are distributed over the single wafer. Ten of the wafer were prepared.

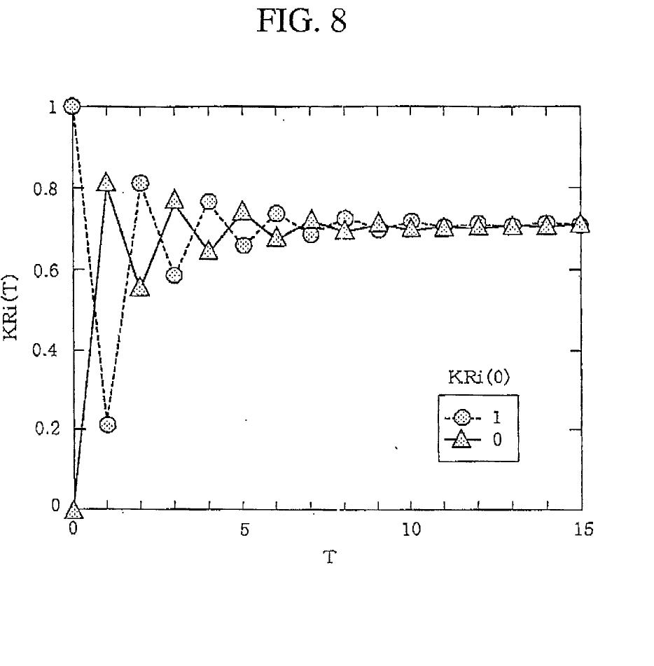

The kill ratios were calculated in accordance with both the conventional method and the above-described novel method with use of the data processor 100. FIG. 8 is a diagram of convergence of the compensated kill ratios “KRi” versus calculation time “T” or the number of calculation operation. The compensated kill ratios “KRi” of the defect specie “A” from the kill ratio calculation termination judgement means 218 become converged as the calculation time “T” increases. As the calculation time “T” is over 10, then the convergence of the compensated kill ratios “KRi” is obtained. The converged values of the kill ratios of the attended species defects are shown on the following table 2.

TABLE 2

| | Kill ratio |
|---|---|
| Model data | 0.7 |
| Conventional method | 0.79 |
| Novel method | 0.71 |

The conventional method was implemented by compensating the kill ratio with the compensation data which reflect to the contribution to the yield by the other species defects. The kill ratio calculated in accordance with the novel method is much closer to the kill ratio obtained using the model data than the kill ratio calculated in accordance with the conventional method. This means that the novel method is much higher in the accuracy of calculating the kill ratio than the conventional method.

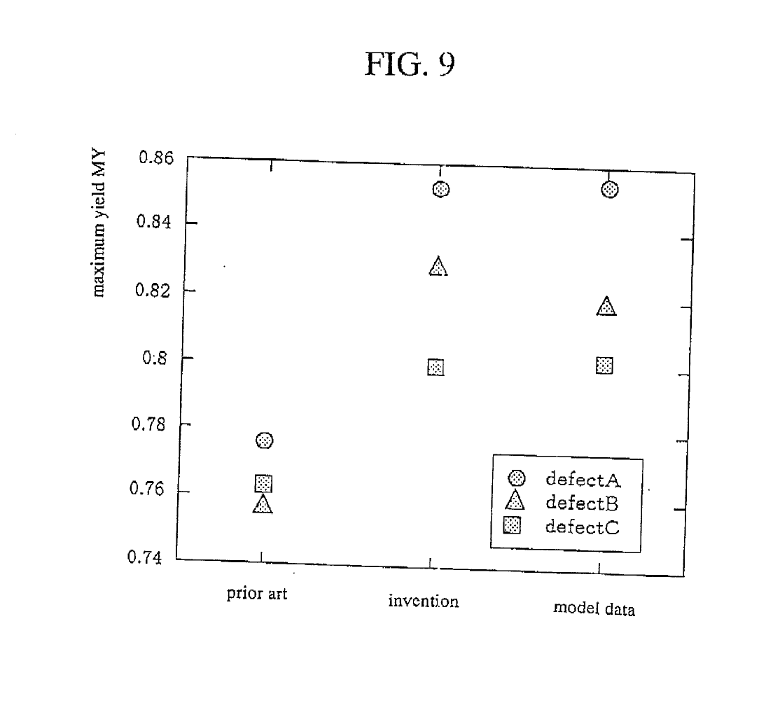

From the above-described calculated kill ratios, the degrees of contributions to the yield by respective species defects were calculated as the maximum yield “MY”. FIG. 9 is a diagram of maximum yields for each of the defect species “A”, “B” and “C” in cases of the conventional method, the novel method and the use of model data. For each of the defect species “A”, “B” and “C”, the maximum yields calculated in accordance with the novel method are much closer to the maximum yields calculated using the model data than the maximum yields calculated in accordance with the conventional method. This means that the novel method is much higher in the accuracy of calculating the maximum yield than the conventional method.

From the above-described calculated kill ratios, the yields were estimated as the total yield “Y”. The following table 3 shows the total yields for the defect specie “A” in cases of the conventional method, the novel method and the use of model data.

TABLE 3

| | Estimated yield |
|---|---|
| Model data | 0.76 |
| Conventional method | 0.67 |
| Novel method | 0.77 |

The total yield calculated in accordance with die novel method is much closer to the total yield calculated using the model data than the total yield calculated in accordance with the conventional method. This means that the novel method is much higher in the accuracy of calculating the total yield than the conventional method.

Any modifications to the above described novel methods may be allowable without changing the subject matter of the present invention defined in the scopes of the above respective aspects of the present invention. The followings are examples of allowable modifications to the above described novel methods.

In the above descriptions, the die investigation data are collected in the single manufacturing process from the ten wafers. It is, however, possible that the die investigation data are collected for each of the plural manufacturing processes for the single wafer, for each of the plural lots including the plural wafers, for the plural lots, and for the kinds of the IC chips. If the die investigation data are collected for all of the above categories, then the user may designate the kinds of the IC chips, the desired lot, the desired wafer in the desired lot, and the desired manufacturing process for the desired wafer before designation to the attended specie of the defect.

In the above descriptions, the CPU 101 exhibits the operations in accordance with the control programs as the software stored in the RAM 104, whereby the above-described respective means as the respective logical functions of the data processor 100 are realized. It is, however, possible that the above above-described respective means as the respective logical functions of the data processor 100 may alternatively realized by respective hardwares. It is also possible that the above above-described respective means as the respective logical functions of the data processor 100 may alternatively realized by combination of hardwares and softwares stored in the RAM 104.

In the above descriptions, the softwares were previously installed into the HDD 105 from the CD-ROM 108 In starting the data processor 100, the softwares are copied to the RAM 104, so that the CPU 101 reads the softwares from the RAM 104. It is, however, possible that the CPU 101 reads the softwares directly from the HDD 105. It is also possible that the softwares are stored in the ROM 103 and the CPU 101 reads the softwares directly from the ROM 103. It is further possible that the softwares are stored in the FD 106 or the CD-ROM 108, so that the softwares are installed into the HDD 105 from the FD 106 or the CD-ROM 108 It is further possible that the softwares are stored in the FD 106 or the CD-ROM 108 and the CPU 101 reads the softwares directly from the PD 106 or the CD-ROM 108

Consequently, if the above-described means of the data processor 100 are realized in the form of the softwares, then the softwares may be stored in the storage medium which allows the CPU 101 to read the softwares therefrom.

The control program may optionally comprise combined plural softwares, so that only the essential softwares for realizing the data processor 100 are stored in a storage medium as a single product. The existent operating system has been incorporated into the data processor 100 and the application software are then provided to the data processor 100 from the storage medium as the single product, such as CD-ROM 108 The softwares realizing the above-described respective means of the data processor 100 are realized by combination of the application softwares and the operating system, whereby parts of the application software may be omitted, wherein the parts depend on the operating system.

The measure of supplying the software to the CPU 101 is not limited to the direct incorporation of the storage medium into the data processor 100, The software may be stored in the storage medium in a host computer, so that the softwares may be downloaded from the host computer to terminal computers connected through a communication network to the host computer. In this case, it is possible that the softwares are down-loaded to the storage medium incorporated in the terminal computer, so that the softwares are implemented by the terminal computer by stand-alone. It is alternatively possible that the software may be implemented by real time data communications between the host and terminal computers without down-load operation. In this case, the data processor corresponds to the network system including the host and terminal computers.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. A method of calculating a kill ratio of an attended defect specie, said method comprising the steps of:
extracting plural defect specie correspondent sets of die investigation data, and said plural defect specie correspondent sets corresponding to plural recognized defect species, and said plural recognized defect species including not only said attended defect specie but also one or more non-attended defect specie; and
implementing a numerical analysis by using said extracted plural defect specie correspondent sets of die investigation data for not only said attended defect specie but also said one or more non-attended defect species, thereby to calculate a kill ratio of said attended defect specie.

2. The method as claimed in claim 1, wherein said die investigation data include respective-specie defect number data for each defect specie and for each of said dies, and defective and non-defective indicating data for indicating defective or non-defective for each final product.

3. The method as claimed in claim 1, wherein said step of implementing said numerical analysis comprises a step of solving simultaneous equations for kill ratios of said plural defect species including not only said attended defect specie but also said one or more non-attended defect specie.

4. The method as claimed in claim 3, wherein said simultaneous equations are given by:
KRi=1−TGi/Σ[II{((1−KRk)ˆ Njk)×((1−KRi*)ˆ (Nji−1))}]
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” present in said final product “j” and “KRi*” is a past-calculated kill ratio.

5. The method as claimed in claim 4, wherein an incorporation of said calculated kill ratio “KRi” into the right side term of said simultaneous equation and a subsequent operation of solving again said simultaneous equations are repeated until a degree of convergence of said calculated kill ratio “KRi” becomes within a predetermined reference value.

6. The method as claimed in claim 3, wherein said simultaneous equations are given by:
$$\begin{matrix}KRi = 1 - TGi \times To / TGo / \sum [ Π \{ ( ( 1 - KRk ) \hat{} Njk ) \times \\ ( ( 1 - KRi *) \hat{} ( Nji - 1 ) ) \} ]\end{matrix}$$
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” present in said final product “j”, “KRi*” is an acceptable past-calculated kill ratio, “TGo” is a number of non-defective dies having the absence of said respective recognized defect species, and “To” is a number of dies having the absence of said respective recognized defect species.

7. The method as claimed in claim 6, wherein an incorporation of said calculated kill ratio “KRi” into the right side term of said simultaneous equation and a subsequent operation of solving again said simultaneous equations are repeated until a degree of convergence of said calculated kill ratio “KRi” becomes within a predetermined reference value.

8. The method as claimed in claim 3, further comprising the steps of:
extracting defect-free die investigation data of defect-free dies which are free of said respective recognized specie defects sorted from said plural defect specie correspondent sets of die investigation data;
preparing compensation data which indicate an unrecognized defect specie contribution degree to said kill ratio, wherein said unrecognized defect specie contribution degree is a degree of contribution by an unrecognized defect specie other than said respective recognized specie defects, and said unrecognized defect specie is sorted based on said extracted defect-free die investigation data; and
compensating said simultaneous equations with said compensation data for solving said simultaneous equations.

9. A method of calculating a contribution degree of an attended defect specie to a total yield, said method comprising the steps of:
calculating respective kill ratios of respective recognized defect species; and
solving an equation given by:
“MYi”=1/T×Σ[II(1−KRk)ˆ Njk]
where “MYi” is a contribution degree of an attended defect specie “i” to the total yield, “KRk” is a respective kill ratio of a respective recognized defect specie “k”, “T” is a total number of final products, and “Njk” is a defect number of said respective recognized defect specie “k” which is present in said final product “j” and which is other than said attended defect specie.

10. The method as claimed in claim 9, wherein said step of calculating respective kill ratios further comprises the steps of:
extracting plural defect specie correspondent sets of die investigation data, and said plural defect specie correspondent sets corresponding to plural recognized defect species, and said plural recognized defect species including not only said attended defect specie but also one or more non-attended defect specie;
implementing a numerical analysis by using said extracted plural defect specie correspondent sets of die investigation data for not only said attended defect specie but also said one or more non-attended defect species, thereby to calculate a kill ratio of said attended defect specie; and
repeating said extracting and subsequent implementing steps by sequentially placing respective one of said plural recognized defect species into said attended defect specie, thereby to calculate said respective kill ratios of respective recognized defect species.

11. The method as claimed in claim 10, wherein said die investigation data include respective-specie defect number data for each defect specie and for each of said dies, and defective and non-defective indicating data for indicating defective or non-defective for each final product.

12. The method as claimed in claim 11, wherein said step of implementing said numerical analysis comprises a step of solving simultaneous equations for kill ratios of said plural defect species including not only said attended defect specie but also said one or more non-attended defect specie.

13. The method as claimed in claim 12, wherein said simultaneous equations are given by:
KRi=1−TGi/Σ[II{((1−KRk)ˆ Njk)×((1−KRi*)ˆ (Nji−1))}]
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” which is present in said final product “i” and which is other than said attended defect specie, and “KRi*” is an acceptable past-calculated kill ratio.

14. The method as claimed in claim 13, further comprising the steps of:
extracting defect-free die investigation data of defect-free dies which arc free of said respective recognized specie defects sorted from said plural defect specie correspondent sets of die investigation data;
preparing compensation data which indicate an unrecognized defect specie contribution degree to said kill ratio, wherein said unrecognized defect specie contribution degree is a degree of contribution by an unrecognized defect specie other than said respective recognized specie defects, and said unrecognized defect specie is sorted based on said extracted defect-free die investigation data; and
compensating said simultaneous equations with said compensation data for solving said simultaneous equations.

15. A method of calculating a contribution degree of an attended defect specie to a total yield, said method comprising the steps of:
calculating respective kill ratios of respective recognized defect species; and
solving an equation given by:
“MYi”=TGo/To/T×Σ[II(1−KRk)ˆ Njk]
where “MYi” is a contribution degree of an attended defect specie “i” to the total yield, “KRk” is a respective kill ratio of a respective recognized defect specie “k”, “Njk” is a defect number of said respective recognized defect specie “k” which is present in said final product “j” and which is other than said attended defect specie, “T” is a total number of final products, “TGo” is a number of non-defective dies having the absence of said respective recognized defect species, and “To” is a number of dies having the absence of said respective recognized defect species.

16. The method as claimed in claim 15, wherein said step of calculating respective kill ratios further comprises the steps of:
extracting plural defect specie correspondent sets of die investigation data, and said plural defect specie correspondent sets corresponding to plural recognized defect species, and said plural recognized defect species including not only said attended defect specie but also one or more non-attended defect specie;
implementing a numerical analysis by using said extracted plural defect specie correspondent sets of die investigation data for not only said attended defect specie but also said one or more non-attended defect species, thereby to calculate a kill ratio of said attended defect specie; and
repeating said extracting and subsequent implementing steps by sequentially placing respective one of said plural recognized defect species into said attended defect specie, thereby to calculate said respective kill ratios of respective recognized defect species.

17. The method as claimed in claim 16, wherein said die investigation data include respective-specie defect number data for each defect specie and for each of said dies, and defective and non-defective indicating data for indicating defective or non-defective for each final product.

18. The method as claimed in claim 16, wherein said step of implementing said numerical analysis comprises a step of solving simultaneous equations for kill ratios of said plural defect species including not only said attended defect specie but also said one or more non-attended defect specie.

19. The method as claimed in claim 18, wherein said simultaneous equations are given by:
$$\begin{matrix}KRi = 1 - TGi \times To / TGo / \sum [ Π \{ ( ( 1 - KRk ) \hat{} Njk ) \times \\ ( ( 1 - KRi *) \hat{} ( Nji - 1 ) ) \} ]\end{matrix}$$
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” which is present in said final product “j” and which is other than said attended defect specie, “KRi” is an acceptable past-calculated kill ratio, “TGo” is a number of non-defective dies having the absence of said respective recognized defect species, and “To” is a number of dies having the absence of said respective recognized defect species.

20. The method as claimed in claim 19, further comprising the steps of:
extracting defect-free die investigation data of defect-free dies which are free of said respective recognized specie defects sorted from said plural defect specie correspondent sets of die investigation data;
preparing compensation data which indicate an unrecognized defect specie contribution degree to said kill ratio, wherein said unrecognized defect specie contribution degree is a degree of contribution by an unrecognized defect specie other than said respective recognized specie defects, and said unrecognized defect specie is sorted based on said extracted defect-free die investigation data; and
compensating said simultaneous equations with said compensation data for solving said simultaneous equations.

21. A method of calculating a contribution degree of an attended defect specie to a total yield, said method comprising the steps of extracting plural defect specie correspondent sets of die investigation data, and said plural defect specie correspondent sets corresponding to plural recognized defect species, and said plural recognized defect species including not only said attended defect specie but also one or more non-attended defect specie;
implementing a numerical analysis by using said extracted plural defect specie correspondent sets of die investigation data for not only said attended defect specie but also said one or more non-attended defect species, thereby to calculate a kill ratio of said attended defect specie;
repeating said extracting and subsequent implementing steps by sequentially placing respective one of said plural recognized defect species into said attended defect specie, thereby to calculate said respective kill ratios of respective recognized defect species; and
calculating a contribution degree of an attended defect specie to a total yield from said respective kill ratios of respective recognized defect species.

22. The method as claimed in claim 21, wherein said die investigation data include respective-specie defect number data for each defect specie and for each of said dies, and defective and non-defective indicating data for indicating defective or non-defective for each final product.

23. The method as claimed in claim 21, wherein said step of implementing said numerical analysis comprises a step of solving simultaneous equations for kill ratios of said plural defect species including not only said attended defect specie but also said one or more non-attended defect specie.

24. The method as claimed in claim 23, wherein said simultaneous equations are given by:
KRi=1−TGi/Σ[II{((1−KRk)ˆ Njk)×((1−KRi*)ˆ (Nji−1))}]
where Σ is for “j”, II is for “k” , “Kri” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” which is present in said final product “j” and which is other than said attended defect specie, and “KRi*” is an acceptable past-calculated kill ratio.

25. The method as claimed in claim 23, wherein said simultaneous equations are given by:
$$\begin{matrix}KRi = 1 - TGi \times To / TGo / \sum [ Π \{ ( ( 1 - KRk ) \hat{} Njk ) \times \\ ( ( 1 - KRi *) \hat{} ( Nji - 1 ) ) \} ]\end{matrix}$$
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” which is present in said final product “j” and which is other than said attended defect specie, “KRi*” is an acceptable past-calculated kill ratio, “TGo” is a number of non-defective dies having the absence of said respective recognized defect species, and “To” is a number of dies having the absence of said respective recognized defect species.

26. The method as claimed in claim 23, further comprising the steps of:
extracting defect-free die investigation data of defect-free dies which are free of said respective recognized specie defects sorted from said plural defect specie correspondent sets of die investigation data;
preparing compensation data which indicate an unrecognized defect specie contribution degree to said kill ratio, wherein said unrecognized defect specie contribution degree is a degree of contribution by an unrecognized defect specie other than said respective recognized specie defects, and said unrecognized defect specie is sorted based on said extracted defect-free die investigation data; and
compensating said simultaneous equations with said compensation data for solving said simultaneous equations.

27. A method of calculating a yield in the absence of an attended defect specie, said method comprising the steps of:
extracting plural defect specie correspondent sets of die investigation data, and said plural defect specie correspondent sets corresponding to plural recognized defect species, and said plural recognized defect species including not only said attended defect specie but also one or more non-attended defect specie;
implementing a numerical analysis by using said extracted plural defect specie correspondent sets of die investigation data for not only said attended defect specie but also said one, or more non-attended defect species, thereby to calculate a kill ratio of said attended defect specie;
repeating said extracting and subsequent implementing steps by sequentially placing respective one of said plural recognized defect species into said attended defect specie, thereby to calculate said respective kill ratios of respective recognized defect species; and
calculating a yield in the absence of said attended defect specie by use of said respective kill ratios and respective numbers of non-attended defect species of respective recognized defect species for each die.

28. The method as claimed in claim 27, wherein said die investigation data include respective-specie defect number data for each defect specie and for each of said dies, and defective and non-defective indicating data for indicating defective or non-defective for each final product.

29. The method as claimed in claim 27, wherein said step of implementing said numerical analysis comprises a step of solving simultaneous equations for kill ratios of said plural defect species including not only said attended defect specie but also said one or more non-attended defect specie.

30. The method as claimed in claim 29, further comprising the steps of:
extracting defect-free die investigation data of defect-free dies which arc free of said respective recognized specie defects sorted from said plural defect specie correspondent sets of die investigation data;
preparing compensation data which indicate an unrecognized defect specie contribution degree to said kill ratio, wherein said unrecognized defect specie contribution degree is a degree of contribution by an unrecognized defect specie other than said respective recognized specie defects, and said unrecognized defect specie is sorted based on said extracted defect-free die investigation data; and
compensating said simultaneous equations with said compensation data for solving said simultaneous equations.

31. A method of calculating a total yield, said method comprising the steps of:
calculating respective kill ratios of respective recognized defect species; and
solving an equation given by:
“Y”=1/T×Σ[II(1−KRk)ˆ Njk]
where “Y” is a total yield, “KRk” is a respective kill ratio of a respective recognized defect specie “k”, “T” is a total number of final products, and “Njk” is a defect number of said respective recognized defect specie “k” which is present in said final product “j”.

32. The method as claimed in claim 31, wherein said step of calculating respective kill ratios further comprises the steps of:
extracting plural defect specie correspondent sets of die investigation data, and said plural defect specie correspondent sets corresponding to plural recognized defect species, and said plural recognized defect species including not only said attended defect specie but also one or more non-attended defect specie;
implementing a numerical analysis by using said extracted plural defect specie correspondent sets of die investigation data for not only said attended defect specie but also said one or more non-attended defect species, thereby to calculate a kill ratio of said attended defect specie; and
repeating said extracting and subsequent implementing steps by sequentially placing respective one of said plural recognized defect species into said attended defect specie, thereby to calculate said respective kill ratios of respective recognized defect species.

33. The method as claimed in claim 32, wherein said die investigation data include respective-specie defect number data for each defect specie and for each of said dies, and defective and non-defective indicating data for indicating defective or non-defective for each final product.

34. The method as claimed in claim 32, wherein said step of implementing said numerical analysis comprises a step of solving simultaneous equations for kill ratios of said plural defect species including not only said attended defect specie but also said one or more non-attended defect specie.

35. The method as claimed in claim 34, wherein said simultaneous equations are given by:
KRi=1−TGi/Σ[II{((1−KRk)ˆ Njk)×((1−KRi*)ˆ (Nji−1))}]
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” which is present in said final product “j” and which is other than said attended defect specie, and “KRi*” is an acceptable past-calculated kill ratio.

36. The method as claimed in claim 34, further comprising the steps of:
extracting defect-free die investigation data of defect-free dies which are free of said respective recognized specie defects sorted from said plural defect specie correspondent sets of die investigation data;
preparing compensation data which indicate an unrecognized defect specie contribution degree to said kill ratio, wherein said unrecognized defect specie contribution degree is a degree of contribution by an unrecognized defect specie other than said respective recognized specie defects, and said unrecognized defect specie is sorted based on said extracted defect-free die investigation data; and
compensating said simultaneous equations with said compensation data for solving said simultaneous equations.

37. A method of calculating a total yield, said method comprising the steps of:
calculating respective kill ratios of respective recognized defect species; and
solving an equation given by:
“Y”=TGo/To/T×Σ[II(1−KRk)ˆ Njk]
where “Y” is a total yield, “KRk”is a respective kill ratio of a respective recognized defect specie “k”, “Njk” is a defect number of said respective recognized defect specie “k” which is present in said final product “j”, “T” is a total number of final products, “TGo” is a number of non-defective dies having the absence of said respective recognized defect species, and “To” is a number of dies having the absence of said respective recognized defect species.

38. The method as claimed in claim 37, wherein said step of calculating respective kill ratios further comprises the steps of:
extracting plural defect specie correspondent sets of die investigation data, and said plural defect specie correspondent sets corresponding to plural recognized defect species, and said plural recognized defect species including not only said attended defect specie but also one or more non-attended defect specie;
implementing a numerical analysis by using said extracted plural defect specie correspondent sets of die investigation data for not only said attended defect specie but also said one or more non-attended defect species, thereby to calculate a kill ratio of said attended defect specie; and
repeating said extracting and subsequent implementing steps by sequentially placing respective one of said plural recognized defect species into said attended defect specie, thereby to calculate said respective kill ratios of respective recognized defect species.

39. The method as claimed in claim 38, wherein said die investigation data include respective-specie defect number data for each defect specie and for each of said dies, and defective and non-defective indicating data for indicating defective or non-defective for each final product.

40. The method as claimed in claim 38, wherein said step of implementing said numerical analysis comprises a step of solving simultaneous equations for kill ratios of said plural defect species including not only said attended defect specie but also said one or more non-attended defect specie.

41. The method as claimed in claim 40, wherein said simultaneous equations are given by:
$$\begin{matrix}KRi = 1 - TGi \times To / TGo / \sum [ Π \{ ( ( 1 - KRk ) \hat{} Njk ) \times \\ ( ( 1 - KRi *) \hat{} ( Nji - 1 ) ) \} ]\end{matrix}$$
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” which is present in said final product “j” and which is other than said attended defect specie, “KRi*” is an acceptable past-calculated kill ratio, “TGo” is a number of non-defective dies having the absence of said respective recognized defect species, and “To” is a number of dies having the absence of said respective recognized defect species.

42. The method as claimed in claim 40, further comprising the steps of:
extracting defect-free die investigation data of defect-free dies which are free of said respective recognized specie defects sorted from said plural defect specie correspondent sets of die investigation data;
preparing compensation data which indicate an unrecognized defect specie contribution degree to said kill ratio, wherein said unrecognized defect specie contribution degree is a degree of contribution by an unrecognized defect specie other than said respective recognized specie defects, and said unrecognized defect specie is sorted based on said extracted defect-free die investigation data; and
compensating said simultaneous equations with said compensation data for solving said simultaneous equations.

43. A method of calculating a total yield, said method comprising the steps of:
extracting plural defect specie correspondent sets of die investigation data, and said plural deject specie correspondent sets corresponding to plural recognized defect species, and said plural recognized defect species including not only said attended defect specie but also one or more non-attended defect specie;
implementing a numerical analysis by using said extracted plural defect specie correspondent sets of die investigation data for not only said attended defect specie but also said one or more non-attended defect species, thereby to calculate a kill ratio of said attended defect specie;
repeating said extracting and subsequent implementing steps by sequentially placing respective one of said plural recognized defect species into said attended defect specie, thereby to calculate said respective kill ratios of respective recognized defect species; and
calculating a total yield from said respective kill ratios of respective recognized defect species.

44. The method as claimed in claim 43, wherein said die investigation data include respective-specie defect number data for each defect specie and for each of said dies, and defective and non-defective indicating data for indicating defective or non-defective for each final product.

45. The method as claimed in claim 43, wherein said step of implementing said numerical analysis comprises a step of solving simultaneous equations for kill ratios of said plural defect species including not only said attended defect specie but also said one or more non-attended defect specie.

46. The method as claimed in claim 45, wherein said simultaneous equations are given by:
KRi=1−TGi/Σ[II{((1−KRk)ˆ Njk)×((1−KRi*)ˆ (Nji−1))}]
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” which is present in said final product “j” and which is other than said attended defect specie, and “KRi*” is an acceptable past-calculated kill ratio.

47. The method as claimed in claim 45, wherein said simultaneous equations are given by:
$$\begin{matrix}KRi = 1 - TGi \times To / TGo / \sum [ Π \{ ( ( 1 - KRk ) \hat{} Njk ) \times \\ ( ( 1 - KRi *) \hat{} ( Nji - 1 ) ) \} ]\end{matrix}$$
where Σ is for “j”, II is for “k”, “KRi” is a kill ratio of said attended defect specie “i”, “TGi” is a number of non-defective dies having the presence of said attended defect specie “i”, “KRk” is a respective kill ratio of a respective recognized defect specie “k”, “Nji” is a defect number of said attended defect specie “i” present in a final product “j”, “Njk” is a defect number of said respective recognized defect specie “k” which is present in said final product “j” and which is other than said attended defect specie, “KRi*” is an acceptable past-calculated kill ratio, “TGo” is a number of non-defective dies having the absence of said respective recognized defect species, and “To” is a number of dies having the absence of said respective recognized defect species.

48. The method as claimed in claim 45, further comprising the steps of:
extracting defect-free die investigation data of defect-free dies which arc free of said respective recognized specie defects sorted from said plural defect specie correspondent sets of die investigation data;
preparing compensation data which indicate an unrecognized defect specie contribution degree to said kill ratio, wherein said unrecognized defect specie contribution degree is a degree of contribution by an unrecognized defect specie other than said respective recognized specie defects, and said unrecognized defect specie is sorted based on said extracted defect-free die investigation data: and
compensating said simultaneous equations with said compensation data for solving said simultaneous equations.
